(19) United States
(12) Patent Application Publication
(10) Pub. No.: US 2020/0029399 A1
(43) Pub. Date: Jan. 23, 2020

(54) HOB SYSTEM

(71) Applicant: WILHELM BRUCKBAUER, Neubeuern (DE)

(72) Inventors: Daniel NEUNHAEUSERER, Neustift (DE); Philipp LACATUSU, Nussdorf am Inn (DE); Alexander SCHADECK, Aschau i. Chiemgau (DE); Philipp ESCHBAUM, Raubling (DE); Siegfried GOESSLER, Bad Aibling (DE); Anton SCHMOELLER, Kufstein (DE); Mario BLERSCH, Brannenburg (DE)

(21) Appl. No.: 16/516,674

(22) Filed: Jul. 19, 2019

(30) Foreign Application Priority Data
Jul. 20, 2018 (DE) 10 2018 212 151.6

(51) Int. Cl. H05B 6/06; F24C 15/20

(52) U.S. Cl. CPC H05B 6/065; F24C 15/2042

(57) ABSTRACT

In a hob system having at least one induction hob and an extractor apparatus, a control device for the control of the extractor apparatus is arranged in an induction generator housing.

### CROSS-REFERENCE TO RELATED APPLICATIONS

This application claims the priority of German Patent Application, Serial No. DE 10 2018 212 151.6, filed on Jul. 20, 2018 pursuant to 35 U.S.C. 119(a)-(d), the content of which is incorporated herein by reference in its entirety as if fully set forth herein.

### FIELD OF THE INVENTION

The invention relates to a hob system. The invention further relates to a control unit for a hob system. Finally, the invention relates to a circuit board.

### BACKGROUND OF THE INVENTION

A hob system with an integrated extractor apparatus is known from EP 2 702 329 B1. In a hob system of this type, the electronic components of the hob and the extractor apparatus are mutually separated.

### SUMMARY OF THE INVENTION

One object of the present invention is the improvement of a hob system having at least one hob and an extractor apparatus.

This object is fulfilled by a hob system having at least one induction hob having an induction generator in an induction generator housing for the accommodation of electronic components thereof, and an apparatus for the downward extraction of cooking fumes, wherein a control device for the control of the apparatus for the extraction of cooking fumes is arranged in the induction generator housing.

A core element of the invention is the arrangement of the control device for the control of the extractor apparatus in an induction generator housing.

The induction generator housing is specifically designed for the accommodation of electronic components of the induction generator, specifically for the accommodation of the power electronics of the induction generator. The electronic components can specifically be arranged on a circuit board.

The integration of fan electronics in the induction generator housing saves costs and facilitates maintenance in the event of servicing.

On the grounds of the integration of the control device of the extractor apparatus in the induction generator housing, fewer cables need to be routed through the hob system. This generates a cost saving, and reduces the complexity of installation.

Integration of the control device of the extractor apparatus in the induction generator housing specifically permits an optimum modular design for the constitution of the hob system. The assembly of fewer individual parts is thus required in production, thereby saving further costs.

Moreover, integration of the control device of the extractor apparatus in the induction generator housing permits the more effective protection of these two components against temperature influences associated with the hob.

Overall, as a result of the integration of the control device of the extractor apparatus in the induction generator housing, the hob system can be configured to a more compact design.

Finally, integration of the control device for the control of the extractor apparatus in the induction generator housing, specifically the arrangement of all the electronic components in the induction generator housing, permits a reduction of the overall cable lengths required, and specifically an improvement of electromagnetic compatibility.

The induction generator housing is specifically configured separately from a housing of the hob system.

The induction generator housing is specifically a constituent of an interchangeable module of the hob system. This facilitates maintenance, in the event of servicing.

According to one aspect of the invention, the induction generator housing is magnetically screened. Specifically, it can be encapsulated and/or sealed and/or insulated.

The power electronics, optionally specifically by means of the induction generator housing, are thermally insulated vis-à-vis the induction hobs and the induction coils.

The generator housing, for the purposes of electromagnetic screening, can be comprised, for example, of plastic coated by metal vapour deposition.

According to a further aspect of the invention, the induction generator housing is cooled. Specifically, one or more fans are provided, which draw air into the housing and direct said air over cooling ribs prior to the expulsion thereof from the housing. This cooling is absolutely essential.

According to a further aspect of the invention, a device for the supply of energy to the components of the hob system is integrated in the induction generator housing. It can specifically be provided that an energy supply device for all the components of the hob system is integrated in the induction generator housing.

This can result in an exceptionally robust and low-maintenance configuration of the hob system.

According to a further aspect of the invention, the hob system comprises one or more induction coils, which are connected to the induction generator in the induction generator housing in a wireless energy-transmitting manner.

Specifically, these can be connected to the induction generator housing by means of a plug connector. A contactless arrangement for the transmission of energy to the induction coils can also be provided.

The induction coils are specifically arranged outside the induction generator housing.

According to a further aspect of the invention, electronic components of the control device for the control of the extractor apparatus and electronic components of the induction generator, specifically for the control of the induction generator, are arranged on a common circuit board.

This also saves costs and facilitates maintenance, in the event of servicing. Specifically, costs for components are saved, and the complexity of assembly is reduced. Moreover, the arrangement of electronic components of the control device for the control of the extractor apparatus and of electronic components of the induction generator on a common circuit board permits an optimum modular design for the constitution of the hob system. The assembly of fewer individual parts is thus required in production, thereby saving further costs.

According to a further aspect of the invention, electronic filters, for example mains filters, are employed jointly for the electronics of the extractor apparatus and the hob electronics.

It is specifically possible for all electronic components for the power supply and control of the combination of hobs in the hob system to be arranged on the common circuit board.

According to a further aspect of the invention, electronic components of a mains filter are further arranged on the circuit board. The design of the hob system is also simplified accordingly.

According to a further aspect of the invention, the electric power supply for all the electronic components of the hob system is integrated in the induction generator housing.

A further object of the invention is the improvement of a control unit for a hob system comprising at least one induction hob and an extractor apparatus.

This object is fulfilled, wherein electronic components of a control device for the control of the extractor apparatus are arranged in an induction generator housing.

Advantages proceed from the subject matter described above.

The induction generator housing is specifically interchangeable. It is specifically configured separately from the overall housing of the hob system. It can preferably be removed and replaced in a simple manner, specifically without the use of tools. This facilitates the maintenance of the hob system.

According to a further aspect of the invention, electronic components of the control device for the control of the extractor apparatus and electronic components of an induction generator, specifically of the control device for the control of the induction generator, are arranged on a common circuit board. The resulting advantages correspond to those already described.

A further object of the invention is the improvement of a circuit board of this type for a hob system.

This object is fulfilled by a circuit board having electronic components of an induction generator for an induction hob and electronic components for the power supply and/or control of an extractor apparatus.

According to a further aspect of the invention, the circuit board further comprises electronic components of a mains filter.

Further details and advantages of the invention proceed from the description of exemplary embodiments, with reference to the figures.

### BRIEF DESCRIPTION OF THE FIGURES

FIG. 1 shows a schematic view of a hob system with an integrated extractor apparatus,

FIG. 2 shows a schematic view of an induction generator housing with an integrated control device for the control of an extractor apparatus, and

FIG. 3 shows a schematic view of a circuit board, upon which hob electronics, extractor electronics and a mains filter are arranged.

### DESCRIPTION OF THE PREFERRED EMBODIMENTS

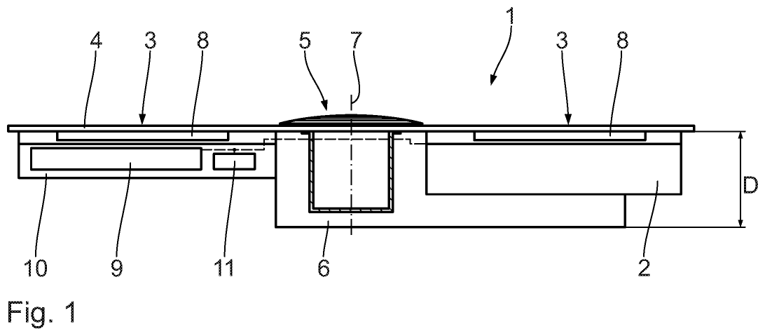

Hereinafter, with reference to FIG. 1, the general layout of a hob system 1 is firstly described by way of example. The hob system 1 comprises a plurality of hobs and an extractor apparatus 2.

The hobs are specifically configured as induction hobs 3.

The hob system 1 is configured as an installation unit. It can be fitted as a fully factory pre-assembled unit into a cut-out in a kitchen work surface. The hob system 1 comprises a cookware surface 4. The cookware surface 4 can specifically be configured as a ceramic glass plate. It can be configured to a one-piece or a multi-piece design.

In the cookware surface 4, a cut-out which serves as a cooking fume intake opening 5 is provided.

The cooking fume intake opening 5 is flowably connected to the extractor apparatus 2.

The extractor apparatus 2 is specifically an apparatus for the downward extraction of cooking fumes. Apparatuses of this type are also described as downflow or downdraft systems. For further details of an apparatus of this type, or a hob system having an apparatus of this type, reference may be made to WO 2012/146 237 A1, which is thus entirely integrated in the present application as a constituent element thereof.

The hob system 1 comprises a system housing 6. The system housing 6 is configured to a compact design. It specifically assumes a height D within the range of 5 cm to 30 cm, specifically within the range of 7 cm to 26 cm, and specifically within the range of 10 cm to 21 cm.

The system housing 6 can essentially be configured to a cuboid design. It can also be configured asymmetrically with respect to a mid-plane 7, specifically wherein the right- and left-hand halves assume different heights.

The induction hobs 3 respectively comprise one or more induction generators 9. The induction generators 9 comprise electronic components, which are arranged in an induction generator housing 10.

Moreover, the induction hobs 3 respectively comprise one or more induction coils 8. The induction coils 8 are arranged on the underside of the cookware surface 4. They are specifically suspended from the cookware surface 4. They are specifically suspended individually.

Alternatively, the coils are not suspended from the cookware surface, but are arranged in contact with the latter, and are supported on the electronics or the induction generator housing 10. Accordingly, by means of the induction generator housing 10, upward pressure is applied to the induction coils 8. The latter are clamped in place accordingly.

The hob system 1 can comprise one or more induction generator housings 10. The induction generator housings 10 are configured separately from the system housing 6. They are specifically configured to a modular design. They are specifically arranged interchangeably in the hob system 1.

The induction generator housings 10 are preferably configured in an encapsulated and/or sealed and/or insulated, specifically thermally insulated and/or magnetically screened arrangement. Specifically, they can be thermally insulated vis-à-vis the hobs.

In the induction generator housing 10, a control device 11 for the control of the extractor apparatus 2 is arranged.

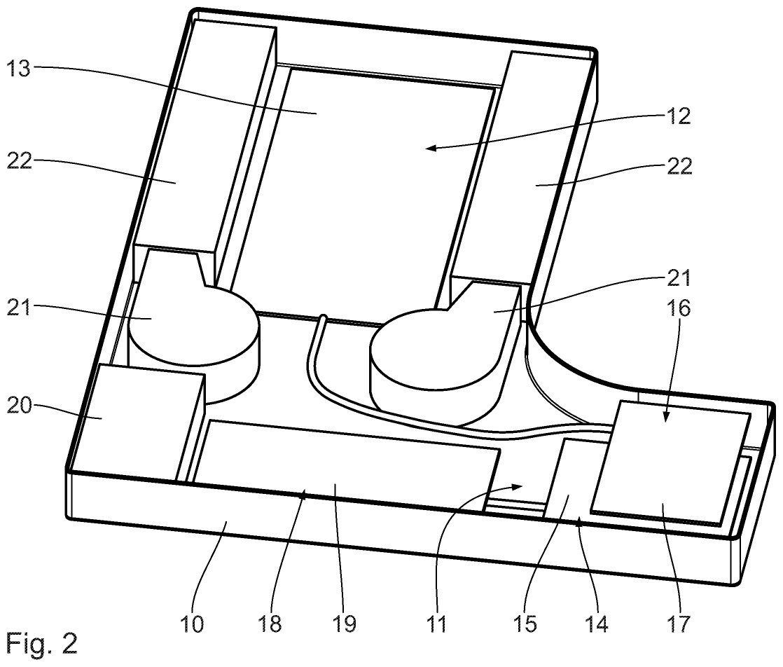

Further details of the hob system 1, specifically the arrangement of the electronic components thereof, are described hereinafter with reference to FIG. 2.

The induction generator housing 10, with the exception of specific openings such as, for example, ventilation openings and penetrations for energy- and/or signal-transmitting connecting elements, is closed. On the side thereof which faces the cookware surface 4, it can be open. It can also be configured in a closed arrangement in the region of its upper side.

The power electronics 12 of the induction generator 9 are arranged in the induction generator housing 10. The power electronics 12 are specifically arranged on a circuit board 13.

Moreover, the control device 11 for the control of the extractor apparatus 2 is arranged in the induction generator housing 10. The control device 11 comprises extractor electronics 14. The extractor electronics 14 are arranged on a circuit board 15.

Operator control electronics 16 are further arranged in the induction generator housing 10. The operator control electronics 16 are arranged on a circuit board 17.

The operator control electronics 16 can comprise electronics for the operation of one or more of the induction hobs 3 and/or the extractor apparatus 2.

Filter electronics 18 are further arranged in the induction generator housing 10. The filter electronics 18 are arranged on a circuit board 19.

The electronic components can be arranged on one or more circuit boards 19.

Moreover, a mains connection is arranged in the induction generator housing 10, specifically in the form of a cable connection box 20.

Finally, two fans 21 are arranged in the induction generator housing 10. Each of the fans 21 is a constituent element of a cooling device for the cooling of the interior space of the induction generator housing 10, and specifically of the electronic components contained therein. The fans 21 are in thermally-conductive contact with one or more heatsinks 22.

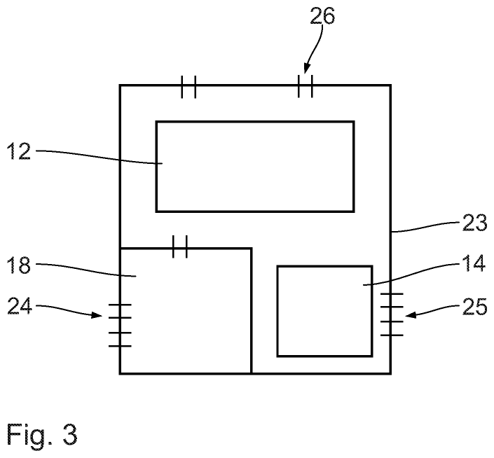

According to an exemplary variant represented in FIG. 3, the electronic components of the control device 11 for the control of the extractor apparatus 2, specifically the extractor electronics 14 and the power electronics 12 of the induction generator 9 are arranged on a common circuit board 23. The filter electronics 18 are moreover arranged on the common circuit board 23.

The circuit board 23 further comprises a mains connection 24. It comprises a first interface 25 for the supply and/or control of the extractor apparatus 2.

The circuit board can incorporate an additional input for the control of the extractor apparatus 2 via the interface 25, during the operation of the hob, which communicates with open fireplaces (window contact switch relay).

It comprises a second interface 26 for the supply and/or control of the heating electronics of the induction hobs 3.

The arrangement of components represented in FIGS. 2 and 3 is to be understood for exemplary purposes only. Other arrangements of the components represented are also possible.

Specific details and advantages of the hob system 1, specifically of the components which are integrated in the induction generator housing 10 or of the electronic components which are arranged on the circuit board 23, will be further illustrated in shorthand form hereinafter.

Control electronics for the extractor apparatus 2 are integrated in the induction generator housing 10, in which the induction electronics of the induction generators 9 are arranged.

The control electronics of the extractor apparatus 2 and the induction electronics are specifically arranged on a common circuit board 23.

Costs, specifically for the production of the hob system 1, can be saved as a result. Maintenance, in the event of servicing, is moreover facilitated by this. Specifically, induction generator electronics and fan control electronics no longer need to be installed separately. Specifically, it is no longer necessary for these electronic components to be mutually spatially separated. They can be integrated in a common housing, specifically on a common circuit board 23.

This permits an optimum modular design. Production involves fewer individual parts needing to be assembled. Furthermore, both the number and length of cables to be routed through the hob system 1 are reduced. Specifically, as a result, the robustness of the hob system 1 is also improved.

Moreover, all the components in the induction generator housing 10 can be cooled by the fans 21. Specifically, components can be more effectively protected against temperature influences associated with the cooking zones of the hob system 1.

According to a variant which is not represented in the figures, the housing can be divided into separate subregions. It is thus possible for the individual electronic components to be individually protected against temperature influences or other disturbances. Both the reliability and the service life of components are enhanced as a result.

The combination of the extractor electronics 14 and the power electronics 12 on the common circuit board 23 permits the enhancement of electromagnetic compatibility. Moreover, the filter electronics 18 can be employed jointly for the extractor apparatus 2 and the power electronics 12.

The induction generator housing 10, with the components integrated therein, can specifically be configured as a simply interchangeable module, specifically as a module which can be interchanged without the use of tools. Dismantling is substantially simplified as a result. Specifically, this simplifies both the assembly and the servicing of the hob system 1.

The induction coils 8 are preferably arranged outside the induction generator housing 10. Specifically, they are suspended individually.

The induction generator electronics, specifically the power electronics 12, can specifically be employed for the supply and/or control of all the induction coils 8 of the induction hobs 3.

Actuation of the electronic components can be executed by means of one specifically central, one specifically centrally arranged or a plurality of operator control units. The operator control unit can also be integrated in the induction generator housing 10. It can specifically comprise a touchscreen.

Moreover, the current and/or voltage supply for all the electronic components can be integrated in the induction generator housing 10.

The induction coils 8 can be directly connected to the induction generator housing 10, specifically by means of a plug-in connection. They can specifically be connected to the induction generator housing 10 in a wireless arrangement. The common employment of electronic filters for the extractor apparatus 2 and the hob electronics improves electromagnetic compatibility.

By the integration of electronic components in the common induction generator housing 10, specifically on the common circuit board 23, an exceptionally compact construction of the hob system 1, specifically a low height D thereof, is permitted. The hob system 1 thus occupies less space in the kitchen layout. This allows more stowage space, specifically for drawers.

What is claimed is:

1. A hob system having
1.1. at least one induction hob having an induction generator housing for the accommodation of electronic components of an induction generator, and
1.2. an apparatus for the downward extraction of cooking fumes,
1.3. wherein a control device for the control of the apparatus for the extraction of cooking fumes is arranged in the induction generator housing.

2. The hob system according to claim 1, wherein the induction generator housing is magnetically screened.

3. The hob system (1) according to claim 1, wherein a device for the supply of energy to the components of the hob system is moreover integrated in the induction generator housing.

4. The hob system according to claim 1, wherein it comprises one of the group comprising one and more induction coils, which are connected to the induction generator in a wireless energy-transmitting manner.

5. The hob system according to claim 1, wherein electronic components of the control device for the control of the apparatus for the extraction of cooking fumes and electronic components of the induction generator (9) are arranged on a common circuit board.

6. The hob system according to claim 5, wherein electronic components of a mains filter are moreover arranged on the circuit board.

7. A control unit for a hob system having at least one induction hob and an apparatus for the downward extraction of cooking fumes, wherein electronic components of a control device for the control of the apparatus for the extraction of cooking fumes are arranged in an induction generator housing.

8. The control unit according to claim 7, wherein electronic components of the control device for the control of the apparatus for the extraction of cooking fumes and electronic components of an induction generator are arranged on a common circuit board.

9. A circuit board having
9.1. electronic components of an induction generator for an induction hob and
9.2. electronic components for at least one of the group comprising the supply of energy and the control of an apparatus for the extraction of cooking fumes.

10. The circuit board according to claim 9, wherein it further comprises electronic components of a mains filter.
